(19) United States
(12) Patent Application Publication
(10) Pub. No.: US 2007/0053015 A1
(43) Pub. Date: Mar. 8, 2007

(54) STILL IMAGE PRINTING METHOD AND APPARATUS CORRESPONDING TO PRINTING REQUEST TIMING

(75) Inventor: Eishi Takeda, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/468,088

(22) Filed: Aug. 29, 2006

(30) Foreign Application Priority Data
Sep. 2, 2005 (JP) 2005-254926
Aug. 2, 2006 (JP) 2006-210889

(51) Int. Cl. H04N 1/04

(52) U.S. Cl. 358/479

(57) ABSTRACT

There is provided a method for printing a still image out of moving images in accordance with a printing request, comprising the steps of generating printing request timing in accordance with an operation by a user; computing the inter-frame difference value between a frame image corresponding to the printing request timing and a frame image of I picture before and/or after the frame image; and determining, based on the computed result, whether the frame image of the above I picture is used as a print prospect or a frame image of P picture before and/or after a frame image corresponding to the printing request timing is used as a print prospect. According to the method of the present invention, it is possible to print a still image without noise deterioration at a high quality.

### BACKGROUND OF THE INVENTION

1. Field of the Invention

The present invention relates to still-image printing method and apparatus for printing a requested still image out of moving image data.

2. Description of the Related Art

Conventionally, there is a request for selecting a desired frame image out of moving image data input from a frame-image unit such as television broadcast, video camera, VTR or DVD/HDD recorder and printing the frame image as a still image by a printer. To realize a function for capturing one frame in moving images and printing it by the present technique, the following method is considered.

(Video Camera)

For example, in the case of a camcorder using a DV tape, the DV terminal of the camcorder is connected with a PC (Personal Computer) by an IEEE1394 cable and a desired image is captured by edition software on the PC and converted to other compression mode such as JPEG and printed out from the PC.

(DVD(Digital Versatile Disc)/HDD(Hard Disc Device) Recorder)

A disk in which data has been recorded by a recorder is inserted into the DVD drive of a PC and a desired image is captured by the edition software on the PC and converted into other compression mode and then printed out from the PC.

Conventionally, as a technique for an image extracting method suitable for printing, there is the technique disclosed in Japanese Patent Application Laid-Open No. 2000-215309.

When extracting one frame image from moving images as a still image out of moving images, noise component becomes easily conspicuous compared to a moving image. This is because the visual sense of a person in the time base direction is insensible (because interpolation between frames is performed), the noise component in one frame is not easily seen.

Particularly, in the case of MPEG data which has been used as a moving-image-data compression mode such as recent DVD or digital broadcast, data is compressed by using the redundancy in the time direction as shown in FIG. 7. Therefore, in the case of contents at a low bit rate and including many movements, deterioration due to noise component becomes more conspicuous by extracting a printing still image from a frame image obtained by coding the difference value between frames (inter-frame difference value) like a B picture.

As shown in FIG. 8, when a user performs printing designation in real time while seeing a display monitor, a delay time occurs from the time when an image to be wanted is seized before the time when printing is designated. Therefore, an image after an image to be actually wanted is printed. Therefore, an undesired image may be printed and availability is not preferable.

### SUMMARY OF THE INVENTION

It is an object of the present invention to provide a still-image printing method and apparatus having no noise deterioration and capable of printing a desired still image at high image quality.

A method of the present invention for printing a still image includes the steps of generating printing request timing in accordance with an operation by a user; computing inter-frame difference value between a frame image corresponding to the printing request timing and a frame image of I picture before and/or after the frame image; and determining, based on the computed result, whether the frame image of the I picture is used as a print prospect or a frame image of P picture before and/or after a frame image corresponding to the printing request timing is used as a print prospect.

Further features of the present invention will become apparent from the following description of exemplary embodiments with reference to the attached drawings.

### BRIEF DESCRIPTION OF THE DRAWINGS

FIG. 1 is a block diagram showing an embodiment of the present invention.

FIG. 2 is an illustration showing the appearance of a recording-reproducing system using the present invention.

FIG. 3 is an illustration showing the appearance of a video camera system using the present invention.

FIG. 4 is an illustration showing a remote controller serving as the operating section of an apparatus of the present invention.

FIG. 5 is an illustration for explaining a still image printing method of the present invention.

FIGS. 6A and 6B are illustrations for explaining another embodiment of a still image printing method of the present invention.

FIG. 7 is an illustration for explaining a conventional technical problem.

FIG. 8 is a conceptual view for explaining delay times of a frame at printing request timing and an actual printing frame.

FIG. 9 is a diagram for illustrating the calculation of a moving distance between frames from an inter-frame difference value by using a block matching method.

### DESCRIPTION OF THE EMBODIMENTS

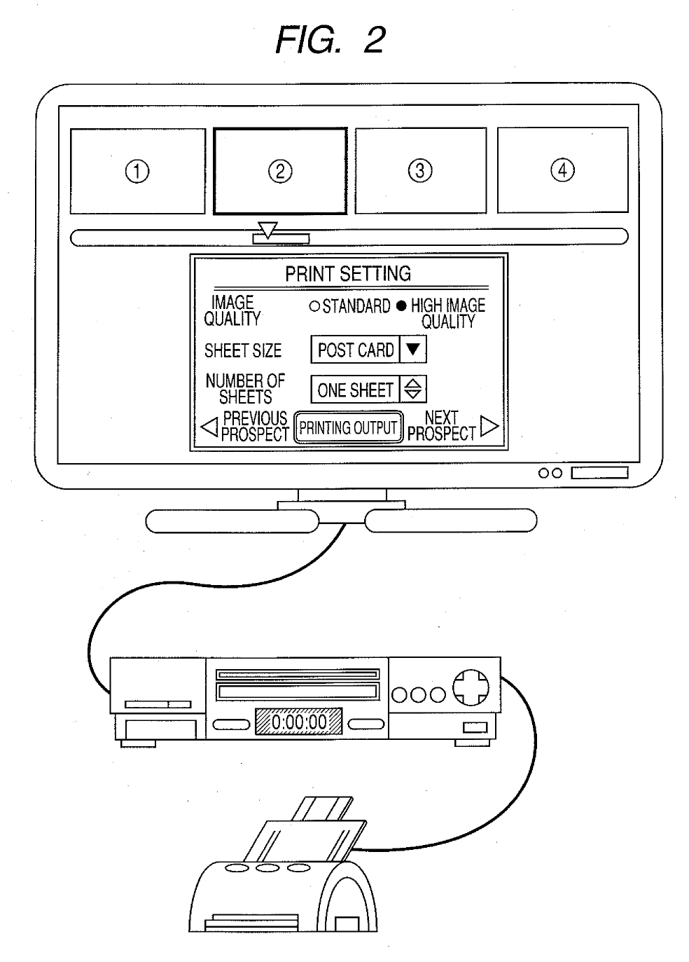

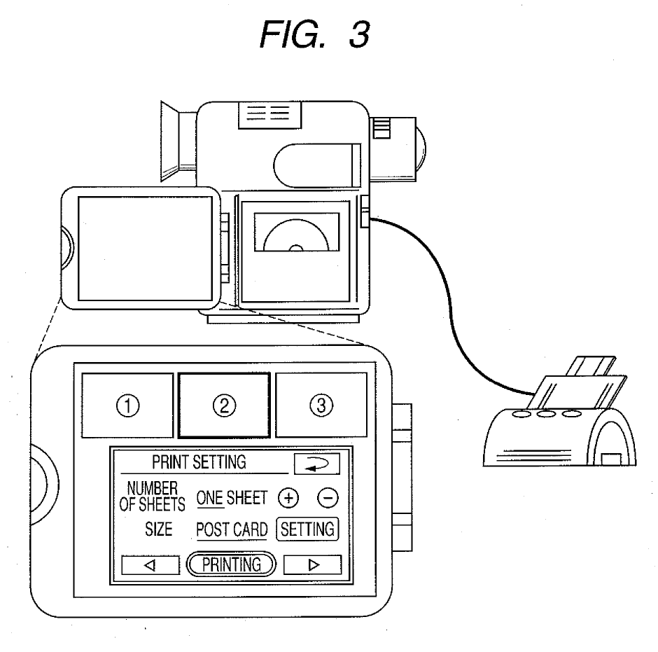

Then, a preferred embodiment for executing the present invention is described below in detail by referring to the accompanying drawings. First, the present invention can be used for a recording-reproducing system using a discoid recording medium such as HDD or DVD connected with a monitor output unit such as the digital television shown in FIG. 2 or a video camera system in which a camera image-pickup section, display output section such as LCD and recording-reproducing mechanism are integrated. FIGS. 2 and 3 show appearances of such units.

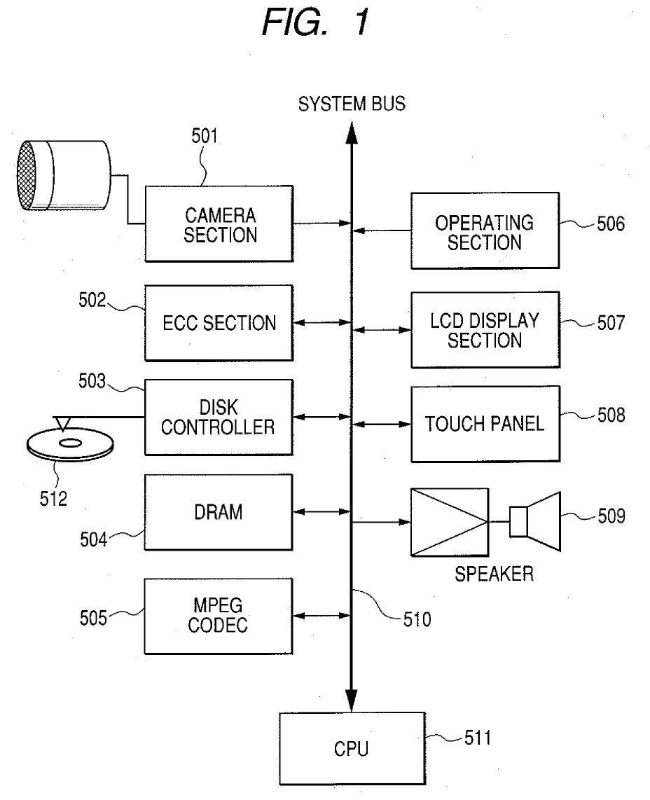

FIG. 1 is a block diagram of an embodiment used for a video camera system having the discoid recording-reproducing mechanism shown in FIG. 3. In FIG. 3, reference numeral 501 denotes a camera section for driving a camera such as image input or focusing, 502 denotes an ECC (Error Correcting Code) section for performing error detection parity addition of data and error correction in actual data in accordance with parity information.

Reference numeral 503 denotes a disk controller section for writing data in a recording medium 512 such as an optical disk or reading data from the recording medium 512, 504 denotes a DRAM (Dynamic Random Access Memory) for accumulating the data necessary for the processing by each system block and 505 denotes a MPEG (Moving Picture Experts Group) codec section for compressing an original image into an MPEG format and decoding MPEG-type data to original image.

Reference numeral 506 denotes an operating section serving as interface for receiving an operation designation from a user by pressing a button or operation designation from a remote controller and communicating the operation designation to a system and 507 denotes an LCD display section (liquid-crystal display) for directly monitor-outputting a camera-input moving image or reading data from a recording medium and then displaying a moving image.

Reference numeral 508 denotes a touch panel set as an interface for a user to control a system from the display screen of the LCD display section 507, 509 denotes a loud speaker for performing voice output after D/A conversion and 510 denotes a system bus for transferring data between blocks or transmitting or receiving a control command. Reference numeral 511 denotes a CPU mounting the software for controlling the whole operation of blocks as a recording-reproducing system.

Then, basic operations of recording and reproducing of the video cameral system of this embodiment are described below. First, in the recording operation mode, uncompressed digital image data AD-converted from the camera section 501 is accumulated in a video frame area of the DRAM 504 via the system bus 510 and at the same time, a frame currently being photographed is display-output on the screen of the LCD display section 507.

The recording operation is started when the CPU 511 receives a command for start of recording from the operating section 506 or touch panel 508 on the LCD display section 507 via the system bus 510. When the CPU 511 receives the recording start command, it controls blocks in a system in accordance with the following sequence.

First, the uncompressed data accumulated in the DRAM 504 is successively data-compressed into an MPEG stream format in the MPEG codec 505 and accumulated in the MPEG data storing area of the DRAM 504 via the return system bus 510.

Moreover, after the ECC section 502 adds a parity bit symbol for error correction to MPEG data, it writes data in the recording medium 512 by the disk controller 503

Furthermore, the recording operation is completed when the CPU 511 receives a command for recording stop from the operating section 506 or touch panel 508 on the LCD display section 507 similarly to start and operations of the ECC section 502, disk controller 503 and MPEG codec 505 are also stopped. However, it is not necessary to stop image input from the camera section 501 and through-display operation to the LCD display section 507.

In the reproducing operation mode, it is possible to know the outline of what contents photographed by a user are stored in the recording medium 512. For example, it is assumed to arrange contracted images (thumb-nail images) prepared by taking out a typical image of moving-image contents and menu-display the image on the LCD display section 507.

In the case of this embodiment, it is not necessary that a menu screen is a thumbnail image such as ID (identifier) or file name assigned for each recorded content. It is allowed that association is realized with positional information necessary for read access when reproducing from which position recorded moving-image data is recorded on a recording medium.

The reproducing operation is started from the fact that the CPU 511 receives a command for start of reproducing from the operating section 506 or touch panel 508 on the LCD display section 507 via the system bus 510 similarly to the time of start of recording. When the CPU 511 receives the reproducing start command, it controls blocks in a system in accordance with the following sequence.

First, the CPU 511 receiving the reproducing start command accesses the recording medium 512 from the disk controller 503 in accordance with the disk control information such as a file system for controlling the position on or size of the recording medium in which moving-image contents to be reproduced are recorded, reads the data to be reproduced to the DRAM 504 and accumulates the data.

Then, the ECC section 502 applies error correction to the data accumulated in the DRAM 504 and read from the recording medium 512 to correct data errors due to a defect or deterioration of the recording medium 512. Then, actual data (MPEG data) excluding parity symbol bit of ECC from the data read after error correction is input to the MPEG codec 505 to decode the MPEG data.

The present image data generated through decoding of the MPEG codec 505 is accumulated in the video frame area of the DRAM 504 and image output is continuously (in the case of NTSC video signal, interval of 30 frames per sec) displayed on the LCD display section 507 via the system bus 510.

Completion of reproducing includes the following two cases: a case in which a medium reading position reaches the dead end of the data for moving image contents (to be detected by the CPU 511) and a case in which the CPU 511 receives a command for reproducing stop from the operating section 506 or the touch panel 508 on the LCD display section 507 via the system bus 510. When reproducing is completed, the display output operation to the ECC section 502, disk controller 503, MPEG codec 505 and LCD display section 507 is stopped.

Then, automatic extraction of a print prospect frame according to the present invention is described. In the case of this embodiment, a recording-reproducing apparatus and a printer having a printout function of a still image can be connected each other by a digital interface cable such as a USB (Universal Serial Bus) and it is assumed that a printer can be controlled from the recording-reproducing apparatus.

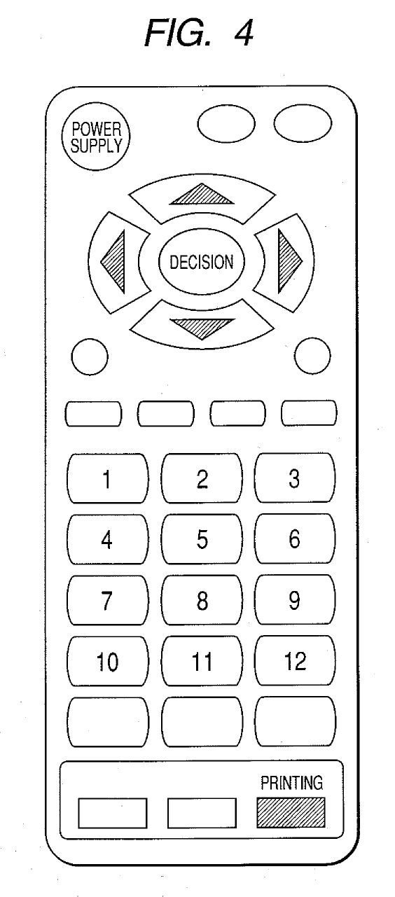

When a user prints a desired display frame while reproducing a moving image, a printing request is issued from the remote controller (provided with a button for designating printing) having the form shown in FIG. 4 following a recording-reproducing apparatus or a button or touch panel built-in the apparatus. It is assumed that any printing request is communicated to a system from the operating section 506 in FIG. 1.

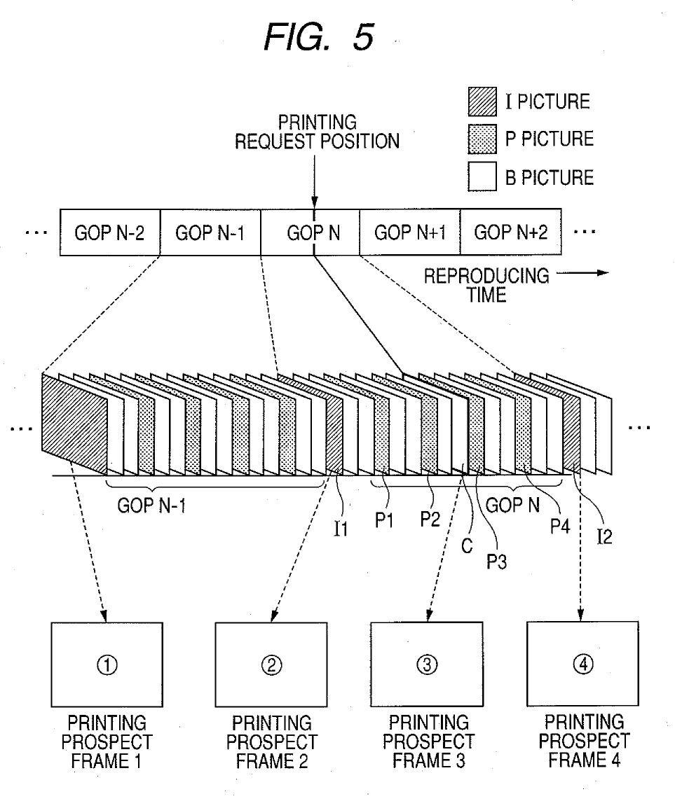

Here, GOP is briefly described. GOP denotes Group Of Picture in MPEG (Movie Picture Experts Group) In general, each GOP includes I picture, P picture and B picture. In the case of the example in FIG. 5, GOP is constituted of 15 pictures (=0 frame) (N=15), the interval between I picture and P picture and the interval between P picture and P picture next to the above P picture are respectively 3 (M=3).

A case in which a frame at the printing request timing is B picture is described below.

When the CPU 511 receives a printing request in accordance with button pressing by a user operation from the operating section 506, the CPU 511 extracts the total of four decoded images corresponds to frame data accumulated in the DRAM 504 corresponding to the reproduced image being currently reproduced and output as shown in FIG. 5, decoded image corresponding to the I picture of GOP in which the frame data is included and decoded image corresponding to the I picture of GOP present before and after the above GOP as print prospects.

FIG. 5 schematically shows the frame data being currently reproduced and output, performs reproducing output such as GOPN−2, GOPN−1, GOPN, GOPN+1, GOPN+2, . . . and the printing request timing from the operating section 506 is set to the reproducing output of GOPN.

As a print prospect frame 1, a decoded image corresponding to the I picture included in GOPN−1 just before the GOPN corresponding to the printing request timing is used, and as a print prospect frame 2, a decoded image corresponding to the I picture of the GOPN corresponding to the printing request timing is used.

As a print prospect frame 3, the frame data for the GOPN corresponding to the printing request timing is used, and as a print prospect frame 4, a decoded image corresponding to the I picture included in the GOPN+1 after the GOPN corresponding to the printing request timing is used. Though four print prospects are used, the number of print prospects is not restricted to four. Extraction of the number of print prospects is optional. For example, it is allowed to extract print prospect frames 2, 3 and 4 or only print prospect frame 2.

The reason why I picture is used as a print prospect is that the compression mode of I picture is in-frame coding (intra-coding) which applies DCT (Discrete Cosine Transformation) processing to a present image every macro block of 8×8 pixels and a DCT coefficient as the result is directly variable-length-coded and I picture is different from P picture and B picture. Therefore, I picture can be decoded and it does not use an estimated value according to movement estimation or movement assurance. Therefore, it is possible to use I picture as a still image suitable for printing including less noise components.

Moreover, in this case, when a corresponding coded print prospect frame is not present on the DRAM 504, MPEG data corresponding to the I picture is read from the above recording medium 512 through the disk controller 503, errors are corrected by the ECC section 502 and then the data is decoded by the MPEG codec 505.

In this embodiment, the number of print prospect frames is four. However, when a large-capacity memory (DRAM 504) is mounted on a recording-reproducing apparatus, it is possible to decrease the access frequency to a recording medium and extract many print prospect frames at high speed. That is, it is allowed to extract decoded images corresponding to I pictures included in GOPN−2, GOPN−3, . . . before GOPN−1 in FIG. 5 or decoded images corresponding to I pictures included in GOPN+2, GOPN+3, after GOPN+1 as print prospects.

However, when many print prospect frames extremely temporally separate from an actual printing request are arranged, selection and decision of a printing frame image become complex. Therefore, a print prospect in several seconds before and after is preferable as an actual solution.

As a method for extracting a plurality of print prospect frames and then showing them to a user so that the user can select them, there is a method for contracting still images of print prospect frames and arranging them in time series on monitor output as shown in FIGS. 2 and 3. Numerals in circles in FIGS. 2 and 3 show still images of print prospects. It is preferable that printout and setting such as printing image quality of and the number of printing frames can be set on the monitor through operations such as a remote controller as a GUI (Graphical User Interface).

Moreover, without the reduction of a print prospect frame and the display of the print prospect by a screen display to the user, it is allowed to automatically extract I picture nearby a frame when a printing request button is directly pressed by the operating section 506 and print out the I picture. An embodiment in that case is described below.

First, I picture for executing automatic extraction for printout is selected as described below. That is, it is determined what-th frame of the GOP structure including a decoded frame when pressing a printing request button (printing request timing) corresponds to and it is decided depending on the result whether the I picture data in the GOP structure is used as a printing frame or the I picture data of the subsequent GOP is used as the printing frame. That is, I picture data closer to a frame image corresponding to the printing request timing is selected as a printing frame.

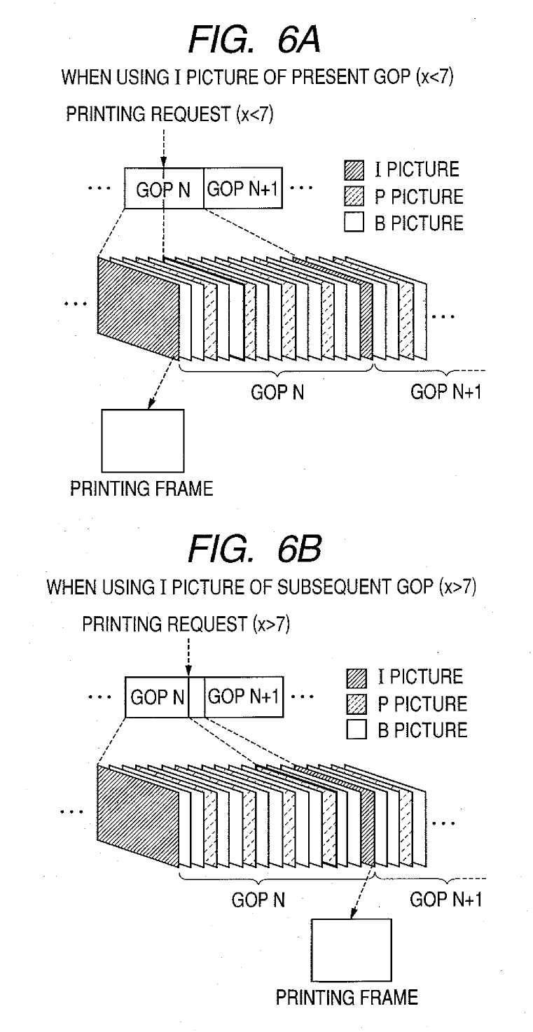

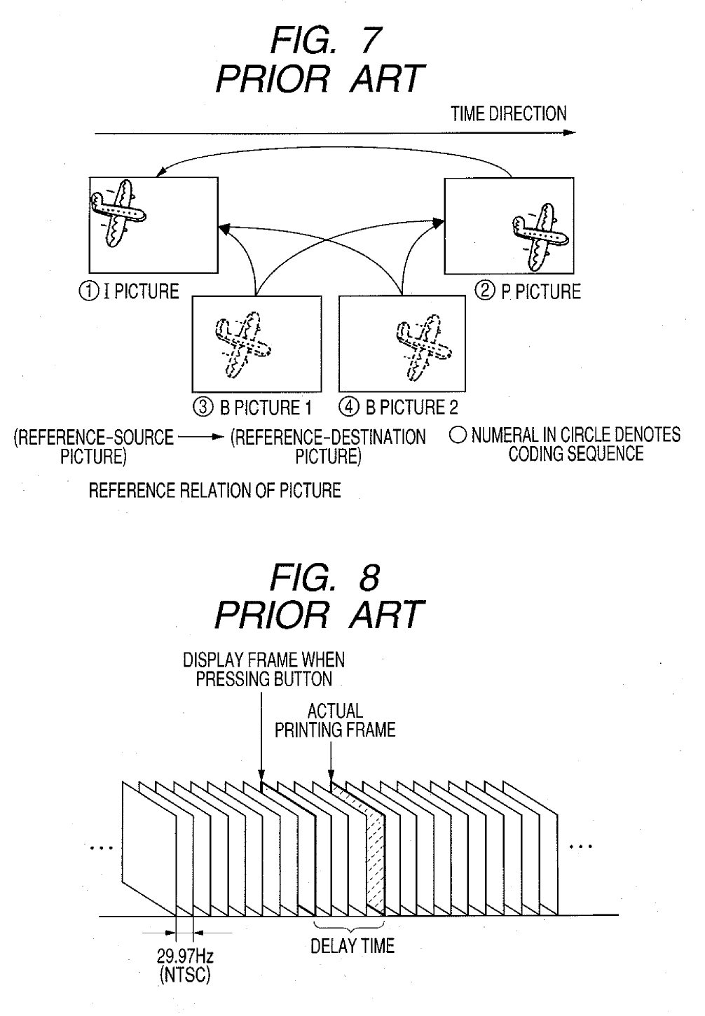

FIGS. 6A and 6B explain a still image printing method of the present invention when decoding and reproducing the MPEG data at the time of constituting 1 GOP of 15 frames. When assuming a decoded-frame number at the time of pressing a printing request button by the operating section 506 (printing request timing) as x, FIG. 6A shows a case in which x is smaller than the seventh decoded frame and FIG. 6B shows a case in which x is equal to or more than the seventh decoded frame.

As shown in FIG. 6A, in the case of x<7, the I picture located at the head of the present GOP (GOPN) including a printing-request decoded frame is used as a printing frame and printed out. On the other hand, in the case of x≧7 as shown in FIG. 6B, the I picture located at the head of GOPN+1 following the present GOP is used as a printing frame and printed out.

By using the above criterion and thereby performing printout, it is possible to decrease the inter-frame difference value present between the printing output frames when printing request button is pressed and the printout frame and as a result, there is an advantage of relaxing uncomfortable feeling to a user.

Moreover, it is allowed to mount a conventional mode for directly printing a display frame corresponding to printing request timing and a mode for extracting and displaying a print prospect by the present invention described in FIG. 5 and performing printing in accordance with selection decision by a user. In addition to that, it is allowed to mount a mode for automatically printing the I picture by the present invention described in FIGS. 6A and 6B and a mechanism for selecting a desired printing mode out of three printing modes so that a user can select any one printing mode by using the selecting mechanism.

Furthermore, there is a case in which a frame image to be printed by a user is absent when displaying a print prospect on a screen as described above. In this case, it is allowed to extract and display still another print prospect in accordance with an operation of the operating section. That is, I picture of GOP present in the past or future of a prospect frame displayed on a screen in accordance with the request of a user. Therefore, data is newly read from the recording medium 512 to display the print prospect on the screen so that a user can select the prospect.

Only a mode for using I picture has been described for a print prospect frame or printout frame. However, when assuming photographing by a video camera, change of images may occur in an order smaller than the time range of GOP such as scene change by sudden movement or fastening photographing of an object.

Therefore, when a spatial and temporal correlation between the display frame when a printing request is issued and I pictures for a print prospect before and after the display frame is low, the inter-frame difference value of a decoded frame when a printing button is pressed and an actual print prospect frame may be increased.

Under the above situation, as one solution for providing a suitable print prospect frame to the user it is allowed to use nearby P pictures (shown as A and B in FIG. 5) as print prospect frames when the printing request button is pressed by the operating section 506 (printing request timing).

Then, when the inter-frame difference value between of the decoded frame at the time of printing request and I picture for a print prospect is large, a processing method for using P picture as a print prospect is described. The following processing is performed by the CPU 511. As first processing, the moving distance between decoded frame at the time of printing request (print prospect frame 3 in FIG. 5) and automatic-extraction I pictures before and after obtained in the previous process as described above (print prospect frames 2 and 4 in FIG. 5) are calculated. It is allowed to calculate the moving distance between frames particularly only for the front I picture instead of front and rear I pictures.

As a method for calculating the moving distance between the frames from the inter-frame difference value, the method for using a global vector calculated in accordance with the pixel value correlation between the field and frame of a reference image and the present image described in Japanese Patent Application Laid-Open No. 2005-354528 as an index is effective.

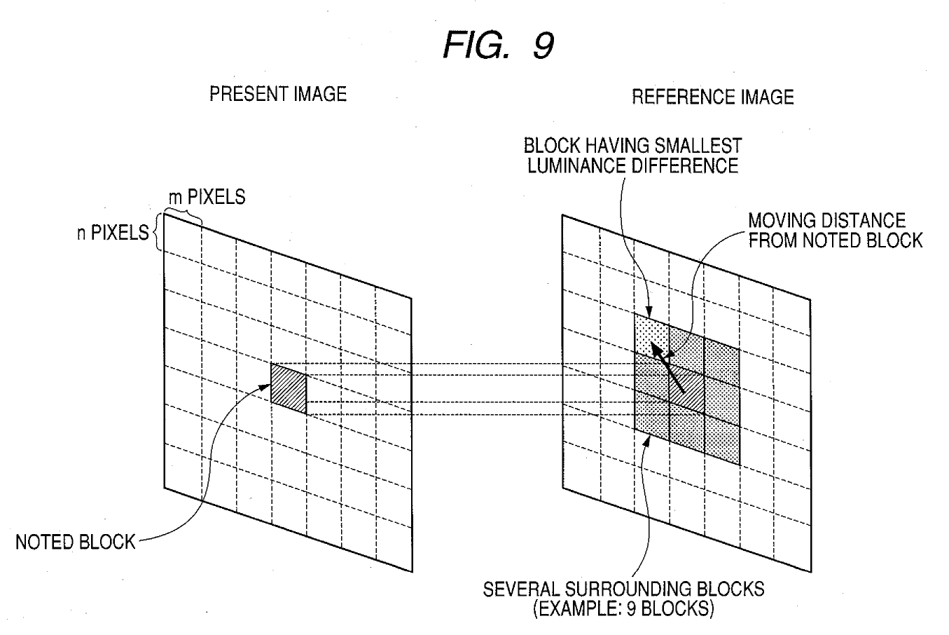

As other calculating method, there is a block matching method. This method is described below by referring to FIG. 9. After area-dividing a frame into blocks of n×m pixels, the luminance value average in each block is calculated for a reference image and present image Then, by noting one block (noted block) in the present image, a block is searched in which the difference between several blocks around a block at the same position as the noted block and the noted block is minimized. Then, a moving distance is calculated from the positional relation between the searched block and the noted block. This operation is applied to all blocks of the present image to sum-of-products-compute the moving distance calculated for each block and use the computed results as moving distances between frames.

An embodiment of the present invention compares the calculated moving distance between frames with a preset threshold value to determine presence or absence of movement between frames in accordance with the comparison result, that is, to determine the magnitude of the inter-frame difference value.

Then, as second processing, it is determined whether the fame is a frame having less movement in accordance with the moving distance between the frames obtained through the first processing. When it is determined that the frame is a frame having less movement, automatic extraction of an I picture only as described above is employed. If not so, it is determined whether to extract the frame as a next prospect frame including P pictures before and after the decoded frame corresponding to the printing request timing.

Then, as the third processing, when a mode for extracting a frame by also including P picture is used by the second processing, for the P pictures near the decoded image when the print request button is pressed a scene is changed between I picture (I1 in FIG. 5) in the N-th GOP in FIG. 5 and the printing request frame (C in FIG. 5), moving distances of the I1 frame and printing request frame becomes large (correlation becomes lower) and the intra-macro-block performing in-frame coding in P pictures (P1 and P2 in FIG. 5) in this interval becomes dominant.

In the case of an embodiment of the present invention, the number of intra-macro blocks (or the number of inter macro blocks) is determined as a result of comparing the number of intra-macro-blocks in a frame or the number of inter macro blocks with a preset threshold value.

When the intra-macro-block in the P2 frame in FIG. 5 is dominant, I1 is not used as a print prospect frame but P2 is used as a print prospect frame. Similarly, when many intra-macro-blocks are present in the P2 frame in FIG. 5, that is, when many intra-macro-blocks are present in P1, P1 is used as a print prospect frame. However, P pictures usually held in a decoding memory are only nearest P pictures (P2 and P3 in FIG. 5) in many cases to save up memory capacity. When the P1 is not already held in the memory, it is allowed to respectively compare moving distances of P2 frame and printing request frame and moving distance (correlation) between the subsequent P3 and printing request frame and use a frame having higher correlation degree as a print prospect.

Then, when scene is changed between the printing request frame (C in FIG. 5) and the I picture of the next N+1st GOP (I2 in FIG. 5), the inter-frame difference value between the printing request frame and I2 frame is large (correlation becomes lower) and the intra-macro-block performing in-frame coding in the P picture in this interval (P3 or P4 in FIG. 5) becomes dominant.

That is, because a frame including many intra-macro-blocks after the printing request frame is lowered in correlation with the printing request frame, it is preferable to use a frame including many inter-macro-blocks

When intra-macro-blocks are dominant in the P3 frame in FIG. 5, P2 located before the printing request frame C is used as a print prospect frame. Similarly, when many inter-macro-blocks are present in the P3 frame in FIG. 5, the moving distance (correlation) between P3 and the printing request frame is compared with the moving distance between P2 and the printing request frame and frame having higher correlation degree is used as a print prospect.

When the printing request frame has a frame structure corresponding to P picture and intra-macro-blocks are dominant, only the printing request frame becomes a print prospect frame and it is allowed not to extract the P picture in the GOP as a prospect.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application Nos. 2005-254926 filed on Sep. 2, 2005, and 2006-210889 filed on Aug. 2, 2006, which are hereby incorporated by reference herein.

What is claimed is:

1. A method for printing a still image out of moving images in accordance with a printing request, comprising the steps of
generating printing request timing in accordance with an operation by a user;
computing inter-frame difference value between a frame image corresponding to the printing request timing and a frame image of I picture before and/or after the frame image; and
determining, based on the computed result, whether the frame image of the I picture is used as a print prospect or a frame image of P picture before and/or after a frame image corresponding to the printing request timing is used as a print prospect.

2. The method according to claim 1, further comprising contracting the frame image determined as the print prospect to display the frame image on the display device.

3. The method according to claim 1, further comprising printing the frame image determined as the print prospect.

4. The method according to claim 1, wherein
the inter-frame difference value is a moving distance between frames.

5. The method according to claim 1, wherein
in the step of determining, when it is determined that the inter-frame difference value between a frame image corresponding to printing request timing and the frame image of I picture before the frame image is large, P picture in which the number of intra-macro-blocks which are present between the frame images is equal to or more than a predetermined value is selected as a print prospect frame image.

6. The method according to claim 5, wherein
in the step of determining, when P picture in which the number of intra-macro-blocks is equal to or more than the predetermined value is not present, an image having higher correlation with a frame image corresponding to the printing request timing among P pictures immediately before and immediately after a frame image corresponding to the printing request timing is selected as a print prospect frame image.

7. The method according to claim 1, wherein
in the step of determining, when it is determined that the inter-frame difference value between a frame image corresponding to printing request timing and a frame image of I picture after the frame image is large and the number of intra-macro-blocks of P picture immediately after a frame image corresponding to the printing request timing is equal to or more than a predetermined value, P picture immediately before the frame image corresponding to the printing request timing is selected as a print prospect frame image.

8. The method according to claim 7, wherein
in the step of determining, when it is determined that the inter-frame difference value between a frame image corresponding to printing request timing and a frame image of I picture after the frame image is large and the number of intra-macro-blocks of P picture immediately after a frame image corresponding to printing request timing is equal to or less than a predetermined value, P picture having higher correlation with a frame image corresponding to the printing request timing among the P pictures immediately before and after the frame image corresponding to printing request timing is selected as a print prospect frame image.

9. The method according to claim 1, wherein
when a frame image corresponding to the printing request timing is P picture, it is selected as a print prospect frame image.

10. An apparatus capable of printing a still image in accordance with a printing request out of moving images, comprising:
a circuit for generating printing request timing in accordance with an operation by a user;
a computing circuit for computing the inter-frame difference value between a frame image corresponding to the printing request timing and the frame image of I picture before and/or after the frame image; and
a circuit for determining, based on the computed result, whether to use the frame image of the I picture as a print prospect or the frame image of P picture before and/or after a frame image corresponding to the printing request timing as a print prospect.
